(19) United States
(12) Patent Application Publication
(10) Pub. No.: US 2022/0369882 A1
(43) Pub. Date: Nov. 24, 2022

(54) SYSTEM AND METHOD FOR CLEANING BAGLESS VACUUM CLEANERS

(71) Applicant: SCIENCE SOLUTIONS LLC, Chicago, IL (US)

(72) Inventors: Monica Kroeger, Lake Forest, IL (US); Chrystine A. Daly, Collegeville, PA (US)

(21) Appl. No.: 17/751,178

(22) Filed: May 23, 2022

Related U.S. Application Data
(60) Provisional application No. 63/191,587, filed on May 21, 2021.

(51) Int. Cl. A47L 9/20

(52) U.S. Cl. CPC A47L 9/20

(57) ABSTRACT

A system for cleaning bagless vacuum cleaners using a first mixture having a surfactant, an odor neutralizer, a fragrance and microorganisms which is used to create a first solution including the first mixture mixed with water. The system includes a second mixture having baking soda, microorganisms, a desiccant and/or additional absorbing agents which is used to create a second solution when mixed with water. At least one component of a bagless vacuum is disassembled and soaked in the first solution, and after the at least one component of the bagless vacuum is dried and reassembled, the second solution is introduced to the interior of the bagless vacuum cleaner to maintain cleanliness.

### RELATED APPLICATIONS

The present application claims priority to, and the filing benefit of, U.S. Patent App. Ser. No. 63/191,587 filed May 21, 2021, the contents of which are fully incorporated herein by reference.

### FIELD OF THE INVENTION

The present invention is related to the cleaning of bagless vacuum cleaners, and more specifically to systems and methods for cleaning and maintaining the components of bagless vacuum cleaners to eliminate and prevent odors in debris capturing and housing elements within bagless vacuum cleaners.

### BACKGROUND OF THE INVENTION

In recent years, bagless vacuum cleaners have become popular as they do not require the use of, and elimination of, waste associated with replaceable bags. Typically, these bagless vacuum cleaners include a canister into which dust, dirt, and debris are deposited after being picked up by the vacuum cleaner and carried to the canister by, for example, a vacuum head and/or any vacuum hoses. Once the canister is full or when an operator is done using the vacuum cleaner, the canister may be emptied directly into a receptacle by using an openable lid and/or base of the canister. As a result of debris which is captured in the canister and moved through various other vacuum components, residue and debris may be left behind, leading to odors and hazardous or harmful conditions if left uncleaned. These odors are significantly heightened when used in areas where animals and pets frequent, as pet hair, dander, dried fluid, residue, food, or other potential odor causing elements may be picked up in the vacuum. In addition to producing odors and allergens on their own, these trapped elements may further facilitate the growth of odor-causing organisms or mites. As a bagless vacuum cleaner and its related components age, various parts may become cracked or pitted enhancing these problems as debris may become trapped within the components, and/or additional surfaces for bacteria to latch onto and grow may be created. Insofar as most bagless vacuum cleaners on the market cannot be washed, there exists a need to create a cleaning and maintenance compound, system, and method to allow users to periodically clean and maintain the components of bagless vacuum cleaners.

The present invention is directed to solving these and other problems.

### SUMMARY OF THE INVENTION

The present invention is directed to mixtures, systems, and methods for cleaning bagless vacuum cleaners to eliminate odors and eliminate and prevent the storage and/or growth of any unwanted debris, residues, or bacteria housed within a bagless vacuum cleaner.

In one embodiment of the invention, the system includes two different stages for cleaning bagless vacuum cleaners. The first stage acts to eliminate odors and residue, for example, from the cannister and other vacuum components, while the second stage acts as a prevention and maintenance stage to inhibit odor-causing bacteria from developing and or re-occurring in the canister and other vacuum components.

In the first stage, a first mixture having at least a surfactant, an odor neutralizer, a fragrance, and a consortium of beneficial, odor-eliminating, and waste-degrading microorganisms is mixed with water to create a concentrated first solution. A vacuum canister and any vacuum filters and/or any other components, such as hoses or attachments, requiring cleaning may be disengaged and removed from the bagless vacuum cleaner and rinsed and submerged in the first solution.

In the second stage, the empty canister and any other disengaged components are re-engaged with the bagless vacuum cleaner in an operable position, and a second mixture including, but not limited to, baking soda, a desiccant and/or additional absorbing agents, and a consortia of beneficial, odor-eliminating, waste-degrading microorganisms, are deposited in a container and combined with water. The second mixture and water remain in the container until the second mixture mixes with and/or absorbs the water at which time the resulting agent may be introduced to the components of the bagless vacuum cleaner. The agent resulting from the second mixture may be left in the canister and any other bagless vacuum components for a period of time before the vacuum is used again, and remain until the canister is emptied. After an initial cleaning using the first stage, the second stage may be done periodically to maintain vacuum freshness and prevent odor production.

Other aspects and features of the invention will become apparent to those having ordinarily skill in the art upon review of the following description, claims, and associated drawings.

### BRIEF DESCRIPTION OF THE DRAWINGS

FIG. 1 shows an exemplary stage 1 of the present invention;

FIG. 2 shows an exemplary stage 2 of the present invention; and

FIG. 3 shows an exemplary flow chart showing the cleaning method of the present invention.

### DETAILED DESCRIPTION OF THE PRESENT INVENTION

While the present invention is susceptible of embodiment in many different forms, there is shown in the drawings and will herein be described in detail several preferred embodiments of the invention with the understanding that the present disclosure is to be considered as an exemplification of the principles of the invention and is not intended to limit the broad aspect of the invention to the embodiments illustrated.

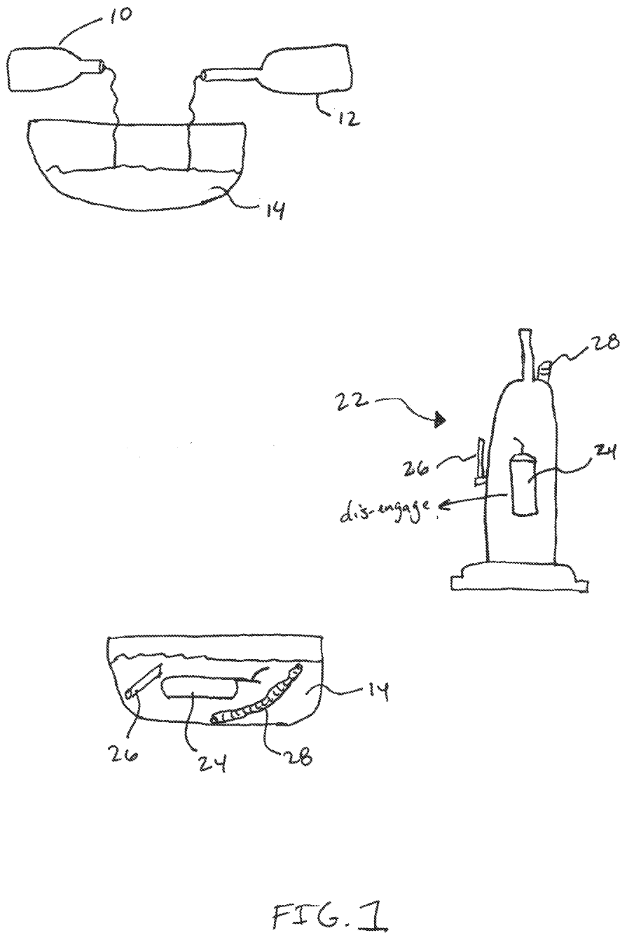

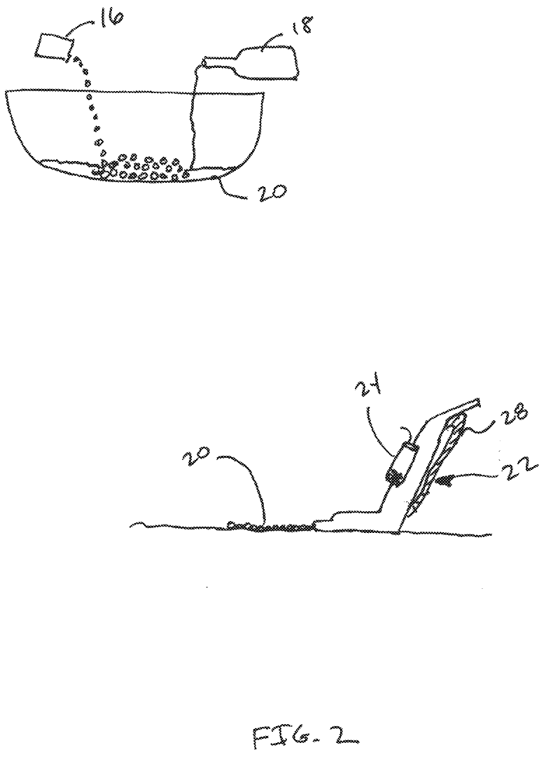

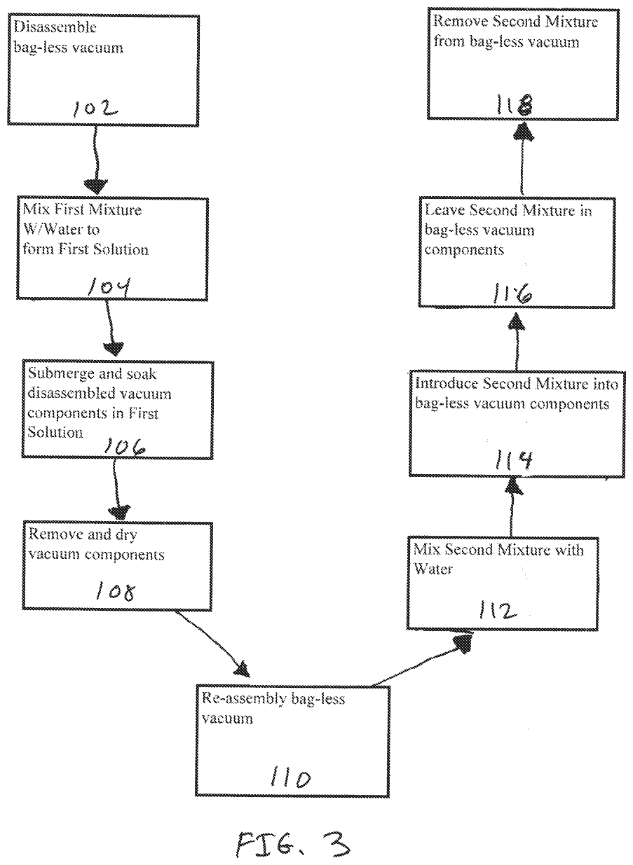

The first and second stages of the system of the present invention can be seen in FIGS. 1 and 2, respectively, with the overall method being seen in FIG. 3. The first stage of the system and first half of the method aim to clean and sanitize the components of bagless vacuums, while the second stage of the system and second half of the method aim to maintain sanitization and help keep a bagless vacuum cleaner clean after the first stage has been completed and usage of the vacuum cleaner has commenced. With periodic repeating of the first stage and second stages of the system, odors, residue, and growth which may be associated with bagless vacuum cleaners may be significantly reduced, or even prevented altogether, as the bagless vacuum cleaner components are continually cleaned and treated to eliminate and prevent the same.

As seen in FIG. 1, the first stage of the system of the present invention comprises mixing a first mixture 10 with water 12 to form a first solution 14, and soaking one or more removable components of a bagless vacuum cleaner in the first solution to sanitize the components. The first mixture may include components which eliminate odors, residue, and/or bacteria from the removable components of the bagless vacuum cleaner, as well as a fragrance to further eliminate existing odors and/or mask any chemical odors of the components of the first mixture.

The first mixture may be in a liquid or a dissolvable form, and may be formed by mixing the following components in the following proportions by weight: 10-20% bacterial concentrate, 0.3-0.6% odor neutralizer, 0.15-0.3% surfactant, 0.1-0.25% fragrance, and 0.05-0.1% NaOH, with the balance of the mixture being water to 100% total weight. The amount of each component may be adjusted within the ranges as necessary to provide the most efficient first solution for use with bagless vacuum components utilized in specific environments. For example, in environments where residue, dust, and dirt are potentially at a higher level, the proportion of surfactant and/or bacterial concentrate may be increased in the first mixture in order to create a more potent first solution for soaking the vacuum components in. Where odors are of greater concern, for example in environments where pets are located and/or food debris may be common, a higher concentration of bacterial concentrate and/or odor neutralizers may be utilized in the first mixture. In other high residue or debris environments and/or environments where surface bacteria may be a concern, only a higher concentration of bacterial concentrate may be utilized in the mixture to result in a first solution which has greater ability to breakdown odorous molecules trapped in the removable vacuum components. The amount of fragrance added to the solution may be increased where greater amounts of non-water proportions are used in the first mixture to help mask any chemical smells, or may be increased to simply to create a more pleasant smelling first solution for an end user.

The bacterial concentrate utilized in the first mixture should include bacteria which degrades or consumes odor causing molecules and/or degrades or consumes particular bacteria or debris which are common to a location. For example, bacteria from the genus Bacillus may be particularly beneficial as bacteria in this genus has the ability to degrade odorous molecules, and maintains this ability for long periods of time in liquid products. Exemplary species within the genus Bacillus which may be utilized include, but are not limited to, Bacillus subtilis, Bacillus megaterium, Bacillus licheniformis, Bacillus amyloliquefaciens and Bacillus pumilus.

In addition to, or in the alternative of, selecting bacteria for a bacteria concentrate which has good odor degradation and/or shelf life, the bacteria included in the concentrate may be tailored to specific desired environments where particular types of debris are encountered more frequently. For example, in some forms of the first mixture, the bacteria concentrate may include bacteria which more actively consumes or degrades pet dander. In other forms, the bacteria contrate in the first mixture may include bacteria which more actively consumes or degrades food molecules or debris. The type(s) of bacteria used in the concentrate may be chosen and/or balanced to meet the requirements of different environments where different forms of residue or debris may become trapped or otherwise engaged with the components of a bagless vacuum cleaner.

The remaining components of the first mixture may likewise be adjusted to meet any particular needs of an environment where a bagless vacuum cleaner may be utilized. The surfactant utilized may, for example, be anionic, nonionic, or a blend of both as desired. The odor neutralizer used in the first mixture may be any chemical or compound which acts to change the structure of odor molecules contained in any bagless vacuum components to reduce or eliminate the odor. Products sold under the tradenames Ordenone®, Metazene®, and Meelium® are exemplary odor neutralizers which may be utilized in the first mixture. Any fragrance may be utilized in the first mixture, but is preferably in a fluid form, and more preferably is oil based.

As seen in FIG. 2, the second stage of the system of the present invention comprises mixing a second mixture 16 with water 18 to form a second agent 20. The second agent may be liquid or solid in form, and should be introduced to, and held in, the components of the bagless vacuum cleaner between uses. The second mixture may include components which eliminate odors and residue and/or bacteria from the removable components of the bagless vacuum cleaner, as well as drying agents to help remove any moisture and/or reduce any humidity from the interior environment of the bagless vacuum cleaner components.

The second mixture may be either liquid or solid in form, and may be formed by mixing the following components in the following proportions by weight: 5-10% bacterial concentrate, 0.5-2% desiccant, 15-25% absorbing agent, and 63-80% baking soda. A fragrance, such as eucalyptus oil, may also be added to the second mixture to enhance the scent of the second agent as it sits in the bagless vacuum components and/or to mask any chemical smell resulting from the second mixture, with the fragrance being added to around 0.5% of the weight of the second mixture to enhance the smell without being overpowering. The amount of each component in the second mixture, like the first mixture, may be adjusted within the ranges as necessary to provide the most efficient agent for use with bagless vacuum components utilized in specific environments. Where odors are of greater concern, for example in environments where pets are located and/or food debris may be common, a higher concentration of bacterial concentrate and/or baking soda may be utilized in the second mixture. Depending on the amount of moisture and/or humidity in the environment or residue commonly encountered by the bagless vacuum cleaner, the amount of desiccant and/or absorbing agent may be increased or decreased as necessary.

The type(s) of bacteria utilized in the bacteria concentrate second mixture may substantially match the bacteria found in the first mixture for any particular system, as both the first and second system will encounter substantially the same bacteria and/or odor causing molecules requiring degradation or consumption to avoid odors. For example, where bacteria from the genus Bacillus is used in the first mixture or a particular system, bacteria from the genus Bacillus may likewise be used in the second mixture within the same system. Any of Bacillus subtilis, Bacillus megaterium, Bacillus licheniformis, Bacillus amyloliquefaciens and/or Bacillus pumilus may likewise be mixed and matched in the second mixture to match first mixture, or different species may be utilized in the second mixture to enhance the effect of the second mixture after the use of the first mixture.

Within the second mixture, any desiccant may be utilized, including, but not limited to any silica-based flow agent, such as silica beads or silica powder. Any absorbing agent used should absorb water effectively to facilitate the drying of the second agent stored within the bagless vacuum components. Exemplary absorbing agents include, but are not limited to, cellulose or cellulose fibers, starch, synthetic polymers, calcium chloride, silica gel, clays, and/or molecular sieves. The second mixture may further include eucalyptus oil as desired.

Though exemplary embodiments are given herein, the first mixture and the second mixture may take any number of physical forms. For example, either of the first or second mixtures may be liquids which mix with water to form a liquid in the case of the first stage, or from a liquid or a solid in the case of the second stage. Either the first stage or the second stage may also be a powder which dissolves in water in the case of the mixture of the first stage, or absorbs water to form beads in the case of the mixture in the second stage. Either the first or second mixture may also take the form of a gel, wax, or other dissolvable substance. The second stage may also be realized as spray used to coat and treat surfaces of a bagless vacuum cleaner. When a spray is used, the spray may include any necessary water mixed into the mixture already, or may be provided in a concentrated form requiring additional water be added. The mixture of the second stage may further be formed on wipes which are packaged wet or dry for the later addition of water, and may be used in either case to wipe down and maintain the surface of the vacuum cleaner surfaces.

In practice, the first stage and second stage may be carried out as follows.

In order to facilitate the first stage as seen in FIG. 1 and the second stage as seen in FIG. 2, a method as seen in FIG. 3 may be implemented. In order to begin the system and method, as seen in FIG. 1, a bagless vacuum cleaner 22 should be disassembled by removing and disengaging any removable components of the bagless vacuum cleaner for which cleaning is required (step 102 in FIG. 3). As seen in FIG. 1, such components may include canister 24, any attachment(s) 26, and/or hose(s) 28. Before or after disengaging the components and disassembling the bagless vacuum, as seen in FIG. 1, first solution 10 should be mixed with water 12 to form first solution 14 (step 104 in FIG. 3). In order to create the first solution, the first mixture may be mixed in a ratio of one (1) part mixture to 64 parts water. For example, approximately four (4) oz or 120 mL of first mixture may be mixed with approximately two (2) gallons or seven and one-half (7.5) L of water. The water may be warmed to facilitate a quicker and more thorough distribution of mixture throughout the solution.

Any components 24, 26, 28 in FIG. 1 which have been removed from the vacuum should then be submerged and soaked in first solution 14 for some period of time (step 106 in FIG. 3). The components may be soaked for a duration of time depending on the amount of sanitation required. For example, cleaner components or components used in environments with less residue and debris may be soaked for a period of 10 minutes, while dirtier components or components used in environments with more reside and debris may be soaked for 30 minutes or longer. Preparing a second or subsequent batches of first solution and submerging the components for a second or subsequent periods of time in any additional first solution may be required for particularly dirty components. Once the components have been soaked for a satisfactory amount of time, the components should be removed from the first solution and dried (step 108 in FIG. 3), and the dried components re-engaged with the vacuum cleaner so that the bagless vacuum cleaner is reassembled (step 110 in FIG. 3), completing the first stage of the system.

After the bagless vacuum is reassembled, as seen in FIG. 2, the second stage may begin by mixing the second mixture (16) with water (18) to create the second agent (20) (step 112 in FIG. 3). Where the second agent is a liquid or powder mixed with water, the second agent may be mixed in the ratio of one (1) part second mixture to four (4) parts water. For example, approximately two (2) oz or 57 g of second mixture may be mixed with approximately one (1) cup or 237 mL of water. The water may again be warmed in order to better facilitate the mixing of the water with the second mixture.

Where the second agent is formed on dry wipes, the wipes may be slightly dampened to activate the second mixture for wiping down any vacuum components. Where the second mixture is placed on wet wipes, the wipes may be ready for utilization immediately.

Once the second agent is created and ready for use, the second agent should be introduced into the bagless vacuum components (step 114 in FIG. 3). Introduction may be accomplished by directly introducing the second agent to desired components, by, for example, spraying, wiping down, or directly placing the second agent inside any vacuum components like a hose, attachments, or canister. Alternatively, the second agent may be placed on a surface over which the bagless vacuum can be used, for example a floor, with the bagless vacuum cleaner being used to vacuum up the second agent through the vacuum head and any hoses before finally reaching and being held in the canister. The second agent can be left in the vacuum components for as long as desired (step 116 in FIG. 3), and can remain until a user decides to empty the canister and all canister contents (step 118 in FIG. 3).

While the second stage should always be completed after the first stage to help ensure that the components are fully sanitized and to help remove any residual moisture from the first stage, it should be understood that the second stage may be repeated in consecutive treatments where the first stage is not required. Doing the second stage repeatedly between first stages may help maintain some level of sanitation within the bagless vacuum when a full cleaning is not required.

The above-described embodiments of the present invention are intended to be examples only. Alterations, modifications and variations may be affected to the particular embodiments by those of skill in the art without departing from the scope of the invention, which is defined by the claims appended hereto.

What is claimed is:

1. A system for cleaning bagless vacuum cleaners comprising:
a first mixture comprising a surfactant, an odor neutralizer, a fragrance and microorganisms;
a first solution comprising the first mixture mixed with water;
a second mixture comprising baking soda, microorganisms, a desiccant and/or additional absorbing agents; and
a second solution comprising the second mixture mixed with water,
wherein at least one component of a bagless vacuum is disassembled and soaked in the first solution, and after the at least one component of the bagless vacuum is dried and reassembled, the second solution is used to treat the bagless vacuum cleaner.

2. The system of claim 1, wherein the microorganisms in the first mixture and the second mixture comprise organisms from the genus Bacillus.

3. The system of claim 2, wherein the microorganism species in the first mixture and the second mixture are one or more from the group comprising Bacillus subtilis, Bacillus megaterium, Bacillus licheniformis, Bacillus amyloliquefaciens or Bacillus pumilu.

4. The system of claim 1, wherein the surfactant is anionic.

5. The system of claim 1, wherein the surfactant is nonionic.

6. The system of claim 1, wherein the surfactant is a blend of anionic and nonionic.

7. The system of claim 1, wherein the odor neutralizer changes the structure of the odor molecule.

8. The system of claim 1, wherein the fragrance is fluid based.

9. The system of claim 8, wherein the fragrance is oil based.

10. The system of claim 1, wherein the first mixture further comprises NaOH.

11. The system of claim 10, wherein the first mixture comprises
10-20% microorganisms by weight;
0.3-0.6% odor neutralizer by weight;
0.15-0.3% surfactant by weight;
0.1-0.25% fragrance by weight;
0.05-0.1% NaOH by weight; and
the balance of the weight of the solution being water to 100%.

12. The system of claim 11, wherein the first solution is created by mixing one (1) part first mixture with 64 parts water.

13. The system of claim 1, wherein the desiccant is a silica-based flow agent.

14. The system of claim 1, wherein additional absorbing agents include one or more from the group comprising cellulose or cellulose fibers, starch, synthetic polymers, calcium chloride, silica gel, clays, and/or molecular sieves.

15. The system of claim 14, wherein the second mixture comprises
5-10% microorganisms by weight;
0.5-2% desiccant by weigh;
15-25% absorbing agent by weight; and
63-80% of baking soda by weight.

16. The system of claim 15, wherein the second mixture is created by mixing one (1) part second mixture and four (4) parts water.

17. A method for cleaning a bagless vacuum cleaner comprising the steps of:
disassembling a bagless vacuum cleaner;
mixing a first mixture having a surfactant, an odor neutralizer, a fragrance and microorganisms mixed with water to form a first solution;
soaking disassembled components of the bagless vacuum cleaner in the first solution;
drying the disassembled components;
reassembling the bagless vacuum cleaner;
mixing a second mixture having baking soda, eucalyptus oil, microorganisms, a desiccant and/or additional absorbing agents with water;
introducing the second mixture and water combination to the interior of the vacuum cleaner.
